(19) United States
(12) Patent Application Publication
(10) Pub. No.: US 2014/0114609 A1
(43) Pub. Date: Apr. 24, 2014

(54) ADAPTIVE ANALYSIS OF SIGNALS

(71) Applicant: HEWLETT-PACKARD DEVELOPMENT COMPANY, L.P., Houston, TX (US)

(72) Inventors: Ron Maurer, Haifa (IL); Alina Maor, Haifa (IL)

(73) Assignee: HEWLETT-PACKARD DEVELOPMENT COMPANY, L.P., Houston, TX (US)

(21) Appl. No.: 13/658,075

(22) Filed: Oct. 23, 2012

(51) Int. Cl. G06F 17/18

(52) U.S. Cl. 702/179

(57) ABSTRACT

Data streams that can be related to operation tracing and/or performance indications, for example, may be monitored. The data streams can have different dynamic statistical characteristics including static signal distributions and non-static signal distributions with respect to time. The data streams may be analyzed independent of any predetermined assumptions on statistical behavior and on changes in the statistical behavior. Data may be transformed into a set of key performance indicators and performance-change indicators that are adaptive to instantaneous statistical changes.

### BACKGROUND

Inspection of systems and their processes frequently involves acquiring data or signals that correspond to the system state or activity, where the data could be either generated by the system or inspected by an external device. For example an inspected data-set could correspond to a temporal sequence of measurements, either at regular time-intervals, conditional upon certain events, or the data-set could correspond to a set of spatial measurements captured by an array of sensors, such as an image.

Whether the acquired data is temporal, spatial, or spatio-temporal, it needs to be analyzed in order to extract meaningful indicators to the system state or activity for purposes of decision support or automated management. Particular tasks include operation monitoring, design optimization, security/safety monitoring, phenomena detection, and more.

### BRIEF DESCRIPTION OF THE DRAWINGS

FIG. 1 illustrated is an example of a high level block diagram of a data-adaptive signal analysis system that outputs statistical characterization and statistical change indicators that are adaptive to instantaneous statistical changes, in accordance with various aspects of embodiments disclosed.

FIG. 2 illustrated is a chart illustrating a weighting scheme in accordance with various aspects of embodiments disclosed.

FIG. 3 illustrated is an example of an empirical cumulative distribution Function (ECDF) profile in accordance with various aspects of embodiments disclosed.

FIG. 4 illustrated is an example of non-parametric estimators for central-tendency and variability in accordance with various aspects of embodiments disclosed.

FIG. 5 illustrated is example of a method for change adaptive analysis in accordance with various aspects of embodiments disclosed.

FIG. 6 illustrated is an example of a method for change adaptive analysis in accordance with various aspects of embodiments disclosed.

FIG. 7 illustrated is an example schematic block diagram for a computing architecture in accordance with certain embodiments of this disclosure.

FIG. 8 illustrated is an example block diagram of a computer operable to a communications framework to execute certain embodiments of this disclosure.

### DETAILED DESCRIPTION

### Overview

One or more implementations of the present disclosure are described with reference to the attached drawings, wherein like reference numerals are used to refer to like elements throughout.

Statistical signal analysis and signal filtering methods account for some of the random aspects of signal generation and signal acquisition mechanisms and attempt to estimate a simplified (filtered) representation of the signal as a low-level first step, in preparation for higher level signal analysis which may involve identification of system states, detection of anomalous system behavior, etc. The existing statistical signal analysis methods can be grossly classified into adaptive vs. non-adaptive, where the non-adaptive methods assume some statistical model of the signal in advance, while adaptive methods adapt the statistical signal model according to the signal data. In particular, adaptive methods try to adapt to certain significant changes in the underlying signal statistics. In doing that, each of the prior adaptive signal analysis methods relies on a different combination of assumptions on the statistical nature of the signal (noise distribution, clean-signal distribution, signal contrast scale, signal to noise ratio, etc.) and the statistical nature of expected changes (gradual vs. abrupt, monotonic vs. fluctuating, change in level vs. change in variability, threshold for meaningful change intensity, and more). The assumptions used in various signal adaptive methods correlate with the class of systems and applications they are designed for.

However, there are many systems and processes with large inherent complexity, where existing adaptive signal analysis methods fall short. Complex systems are characterized by complex internal states that change frequently by a large variety of mechanisms, and where various system measurements or process indicators can switch between multiple operational modes, each leading to different statistical properties of the corresponding signals. Hence in such systems, each of the inspected signals may be a frequently changing random mixture of statistical distributions coming from different underlying processes. In addition, some of statistical distributions involved may be long-tailed or heavy-tailed, meaning that there the signal has a non-negligible probability of exceptionally large or small values. Under such challenging conditions, no single set of prior statistical assumptions as used by prior adaptive signal methods would hold. Therefore there is a need for adaptive statistical signal analysis method which does not rely on a-priori statistical assumptions on the signal distribution and its dynamics (the nature of statistical changes).

Traditional non-adaptive signal filtering uses fixed sample weighting and attributes to each sample a relative importance weight according to its location in the window w(l), such that the weights are normalized Σₗw(l)=1.

The location l may correspond to one dimension (e.g., time in time-series), or to more dimensions (e.g., two spatial dimensions in images). For example in a “causal” setting for time-series filtering, the right most sample l=L−1 is given the highest weight, and weights are decreasing from right to left with increasing distance from the right end—e.g., w(l)=2(L−l)/(L*(L−1)). When the index n corresponds to time, we call this weight profile “temporal proximity profiling”. The traditional signal filters further go to estimate a single characteristic value representing all the samples in the window, the most ubiquitous example being the weighted mean which corresponds to the convolution between the signal y and the weight profile (kernel) w: μ(k)=Σₗw(l) y(k−l)=[w*y](k). The weighted mean is in fact just one possible choice for a characteristic value describing the distribution of weighted values in the window. While it is the optimal estimator for mean of a Gaussian distribution, it is sensitive to even a small portion of very large values and hence, it is not robust against edges (distribution changes in space or time), outliers (mixture with very different distributions), and long-tailed distributions (non-negligible probability for very large or very small values).

There are many works in the non-linear filtering field that address this non-robustness issue, and which rely each on different assumptions on the signal and noise statistics. One family of such techniques applies adaptive weighting of the window samples to account for statistical changes within the window—e.g., bilateral filters, or M-estimation based filters. These techniques typically modify the sample weights if they detect significant differences between window-sample values and the some reference value corresponding to the sample of interest. The significance of differences is judged relative to some absolute “edge-contrast” threshold (either provided in advance or estimated from the data). These techniques do not work well for long-tailed distributions, and their effectiveness for edge-preservation and outlier rejection is limited—mainly to cases where the window data has one main mode containing considerably more than 50% of the distribution-mass. A complementary family of robust filtering techniques replaces the weighted mean by rank-based estimators (R-estimators), e.g. weighted median, or linear combinations of order-statistics (L-estimators), e.g. alpha-trimmed mean. R-estimators and L-estimators are more robust against long-tails, outlier mixtures, and edges, but only to a limited extent. In particular, they are ignorant of the mixture-structure of the distribution—and work well only if the window data has one main mode containing considerably more than 50% of the distribution-mass. Both adaptive-weighting and R-estimator methods presented above ignore the mode-structure of the window sample, and ignore the difference between stationary mixtures (incoherent changes in distribution by a random mechanism), and edges (non-stationary and coherent changes in distribution). This limits their ability to estimate correctly the characteristics of wild statistical distributions that may appear in real-life data, with mixtures of long-tailed distribution and frequent changes in both the constituent distributions and the mixing distributions. It also limits their change-detection accuracy in terms of false-alarms and miss-detects.

A non-linear signal analysis and filtering scheme is described as one embodiment herein, which generalizes both adaptive-weighting techniques and rank-based estimation techniques to be independent of contrast-thresholds, provides coherent change detection, and is more robust than prior methods to the combination of frequent-changes, outliers, and long-tails.

A method is described that includes analyzing data-streams and signals, to obtain corresponding statistical distribution characterization indicators and statistical change indicators, where the analyzed data streams can include different dynamic statistical characteristics including regions of static signal distributions and regions of non-static signal distributions. The data-streams are analyzed independently of predetermined assumptions on statistical behavior and independently of predetermined assumptions on changes in the statistical behavior. Based on this analysis, each of the data streams is transformed into a set of statistical characterization and statistical change indicators that are adaptive to instantaneous statistical changes. As an example, the method is applied to monitoring system tracing data-streams related to operation tracing and performance indication, in which the extracted statistical indicators are used as key performance indicators (KPIs), and performance change indicators for supporting performance management of the system under monitoring.

In one example of the analysis, “rank-based change-adaptive weighting” is designed to detect coherent changes in distribution across a window of data-samples, and adapt the sample weight profile accordingly. It operates by assessing the randomness of ranks distribution across the window. The hypothesis that is assessed is that all samples in the window come from the same distribution (without assuming anything on the distribution shape or scale). If this hypothesis is valid, then any rank has equal chances to appear in any location l in the window, i.e., the rank has a uniform distribution, and in particular, an expectation of <r>(l)=0.5, regardless of location.

### Change-Adaptive Analysis of Signals

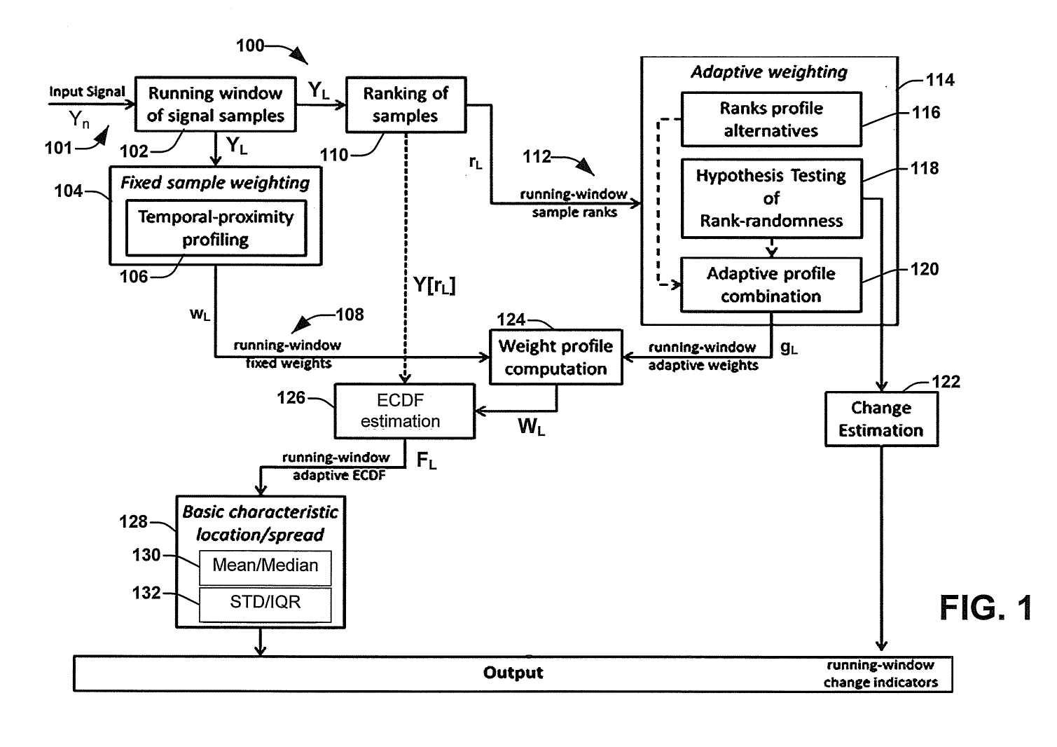

FIG. 1 illustrates an example of a data-adaptive signal analysis suite 100 having statistical analysis components that operate on data streams and signals to provide statistical indicators characterizing the instantaneous statistical distribution of each signal, and an indication of instantaneous changes of statistical distribution, such that all statistical indicators are adaptive to instantaneous statistical changes. The signal's statistical distribution is assumed to be dynamically changing and does not necessarily follow a parametric model. The distribution can have multiple statistical modes (statistical mixture), and each of the statistical modes could also have any distribution-tail behavior (regular-tailed like e.g. Gaussian distribution, long-tailed like e.g. Weibull distribution, or short tailed-like e.g. Uniform distribution). An example of such “wild” dynamic signals, is the series of time-intervals between successive events of some sort, such as system errors/warnings, incoming jobs, logins into a web-server, transactions of certain type, etc.

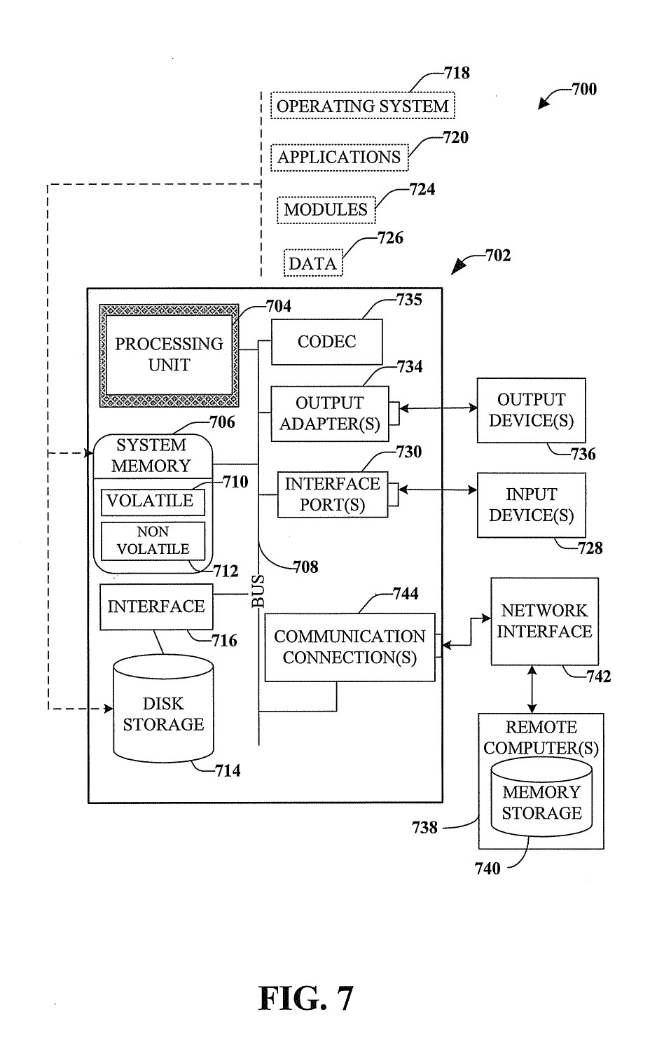

The signal analysis suite (or system) 100 is able to adapt to instantaneous changes of statistical distribution without making any prior assumptions on the shape of scale of the signal's statistical distribution, and the dynamic characteristics of the statistical change (e.g. change in location, scale, shape, abruptness of change, etc.). Each component illustrated in the system further illustrates an analysis of the data from inputs or outputs from a prior or subsequent component. Embodiments disclosed herein can, for example, identify instantaneous characteristic signal value (central tendency), instantaneous signal variability above and below the characteristic value, instantaneous signal change and trend indication, and so forth. These statistical indicators can for example identify various key performance indicators of the system generating the analyzed signals such as characteristic level of various measurements, variability or stability level of each indicator, and indicators of significant changes in characteristic level or variability of the monitored signals. System 100 can include a memory that stores computer executable components and a processor that executes computer executable components stored in the memory, examples of which can be found with reference to FIG. 7. It is to be appreciated that the computer 702 can be used in connection with implementing one or more of the systems or components shown and described in connection with FIG. 1 and other figures disclosed herein. One high-level goal of the system 100 is to extract from monitored system signals useful key performance indicators (KPIs) independently of predetermined assumptions on data distribution shapes, scales and/or location parameters (e.g., thresholds) including any models that are based on statistical behavior for the system tracing data streams and/or changes in the statistical behavior. Given the large heterogeneity of signal or data-stream distributions and the large number of data-streams to be monitored, it is often impractical to utilize expert knowledge on typical signal values and expected variability. Thus, the system 100 is designed to be completely blind and independent of any prior knowledge (e.g., a priori knowledge of statistical characteristics of the data streams) of the data-distributions, scales (e.g., time scales or any scale) and location parameters such as outlier thresholds and the like. The system 100 further overcomes the inadequacies of traditional statistical processing control (SPC) methodology for the hard dynamic data-statistics such as the event-interval statistics mentioned above.

The system 100 comprises a running window component 102 that receives a real valued input signal 101 denoted as y(n), where n is an integer. The running window component 102 is configured to perform a block-wise analysis on running (overlapping) blocks of data of predetermined length L, in which a neighborhood of values is sampled as a block or a window. For example the k^{th} block contains the samples y(k−l) with l=[0: L−1] denoting their position, for example, such as being relative to the right end of the block at k. A fixed sample weighting component 104 receives the running blocks of data of predetermined length L, denoted as a vector Y_{L} or as y(l). The fixed sampling weighing component 104 performs a part of a non-adaptive signal filtering procedure that uses fixed sample weighting and attributes to each sample a relative importance weight 108 according to its location in a window w(l), such that the weights are normalized Σₗw(l)=1. For example in a “causal” setting, the right most sample l=L−1 is given the highest weight (size), and weights are decreasing from right to left with increasing distance from the right end—e.g. w(l)=2(L−l)/(L*(L−1)).

The fixed sample weighting component 104 includes a temporal-proximity profiling component 106 that corresponds the index n to generate a weight profile w(l) (or denoted as w_{L}) via a temporal proximity profiling. The fixed sample weighting component 104 can include any type of fixed sample weighting filter and is operable to further determine a single characteristic value representing all the samples in the window, the most ubiquitous example being the weighted mean which corresponding to the convolution between the signal y and the weight profile (kernel) w: μ(k)=Σₗ w(l) y(k−l)=[w*y](k). The weighted mean is in fact just one possible choice for a characteristic value describing the distribution of weighted values in the window. While it is the optimal estimator for mean of a Gaussian distribution, it is sensitive to even a small portion of very large values and hence, it is not as robust against edges (distribution changes in space or time), outliers (mixture with very different distributions), and long-tailed distributions (non-negligible probability for very large or very small values).

In one embodiment, an adaptive weighting is performed on normalized ranking of samples by the adaptive weighting component 114, which addresses non-robustness issues in the fixed sample weighting component 104. The adaptive weighting component 114 applies adaptive weighting of the window samples to account for statistical changes within the window.

The techniques used by some filters (e.g., bilateral filters, or M-estimation based filters) can modify the sample weights if significant differences are detected between window-sample values and some reference value corresponding to the sample of interest. The significance of the differences can be judged relative to an absolute “edge-contrast” threshold (either provided in advance or estimated from the data). However, these techniques are not always optimal for long-tailed distributions, and their effectiveness for edge-preservation and outlier rejection is limited—mainly to cases where the window data has one main mode containing considerably more than 50% of the distribution-mass. Therefore, a complementary family of robust filtering techniques replaces the weighted mean by rank-based estimators (R-estimators), e.g. weighted median, or linear combinations of order-statistics (L-estimators), e.g. alpha-trimmed mean. R-estimators and L-estimators are more robust against long-tails, outlier mixtures, and edges to a certain extent. In particular, they are ignorant of the mixture-structure of the distribution—and work well if the window data has one main mode containing considerably more than 50% of the distribution-mass. Both adaptive-weighting and R-estimator methods presented above ignore the mode-structure of the window sample, and ignore the difference between stationary mixtures (incoherent changes in distribution by a random mechanism), and edges (non-stationary and coherent changes in distribution). This limits their ability to estimate correctly the characteristics of wild statistical distributions that may appear in real-life data, with mixtures of long-tailed distribution and frequent changes in both the constituent distributions and the mixing distributions. It also limits their change-detection accuracy in terms of false-alarms and miss-detects.

In an example of the adaptive weighting component 114 is configured to perform a non-linear signal analysis and filtering scheme that generalizes both adaptive-weighting techniques and rank-based estimation techniques to be independent of contrast-thresholds, provide coherent change detection (e.g., for both uni-modal and multi-modal distributions), and be more robust than prior methods to the combination of frequent-changes, outliers, and long-tails.

The adaptive weighting component 114 receives a ranking of samples 112 in the window as denoted by r_{L}, which is generated by a ranking of samples component 110. The ranking of samples component 110 performs a sorting and a ranking of the samples Y_{L} in the window. The ranks span the range from 1:L, such that a sample with rank [R] has a value larger than all samples with smaller ranks k<R. According to statistical convention, a group of samples that have the same value are all attributed the same rank which is the center of the ranks-range they occupy, e.g. if 4 sample occupy ranks 4:7, they are all attributed rank 5.5. We further define for convenience the normalized ranks [r] that are limited to the range 0-1 and symmetric about 0.5, regardless of the sample window size L: r≡(R−½)/L.

The adaptive weighting component 114 performs a rank-based change-adaptive weighting of the samples based only on the sample positions and ranks 112. For example, the adaptive weighting component 114 is configured to detect coherent changes in distribution across the window, and adapt the data sample weight profile accordingly. The adaptive weighting component 114 includes a rank profile component 116, a hypothesis testing component 118 and an profile combination component 120.

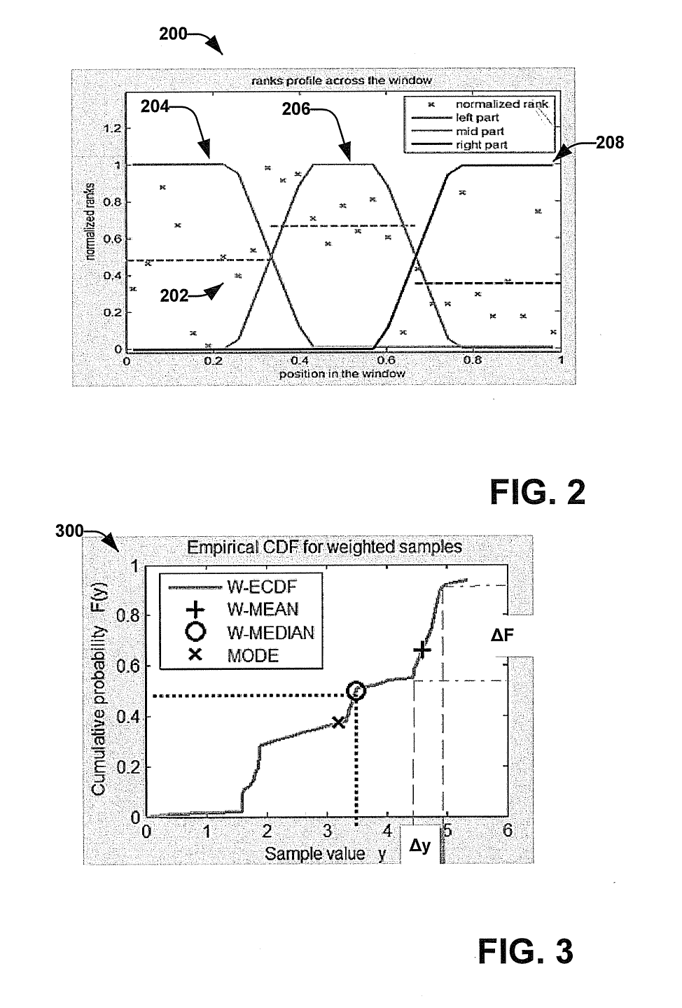

The adaptive weighting component 114 is operable to assess the randomness of ranks distribution across the window. The rank profile component 116 is operable to compute or define a localized set of weight-profiles, such as the set of weight profiles 200 as illustrated in FIG. 2. For example, further referring to FIG. 2 weight-profiles 204, 206 and 208 can be defined, in which each weight-profile corresponds to a window or block region of data samples of a temporal neighborhood.

Referring again to FIG. 1, the hypothesis testing component 118 is configured to test a hypothesis (e.g., a null hypothesis). For example, hypothesis testing component 118 can assess the hypothesis that all samples in the window come from the same distribution (without assuming anything on the distribution shape or scale) or being void of any model or a priori knowledge of the distribution as an adaptive, dynamic analysis. If the hypothesis is valid, then any rank has equal chances to appear in any location L in the window, i.e., the normalized rank r has a uniform distribution, and in particular, an expectation of <r>(L)=0.5, regardless of location. This also means that the expectation of ranks in any region of the window (spanning multiple consecutive locations), should also be 0.5. The hypothesis testing component 118 samples any non-negative weight profile within the window W_{L}, and compute a corresponding weighted mean of the ranks (profile-mean rank) its expectation is also 0.5, regardless of the profile weight or location:

$${μ}_{r} = \frac{{\sum }_{l} W ( l ) \cdot r ( l )}{{\sum }_{l} W ( l )} -> 〈 {μ}_{r} 〉 = \frac{{\sum }_{l} W ( l ) \cdot 〈 r ( l ) 〉}{{\sum }_{l} W ( l )} = \frac{{\sum }_{l} W ( l ) \cdot 0.5}{{\sum }_{l} W ( l )} = 0.5 \qquad Eqn . 1$$

The hypothesis testing component 118 utilizes Eqn. 1 to design a set of statistical tests for statistical significance score and to compare between profile-mean-ranks corresponding to different regions of the window to assess or reject the rank-randomness hypothesis in a constructive manner, while also providing to the change estimation component 122 information on the location of change if such is detected in the window. The hypothesis testing component 118 initially receives a number K of alternative non-negative weight profiles gₖ(l) as determined by the rank profile component 116 such that the profiles sum to unity at all locations Σₖgₖ(l)=1, in which K can be any positive integer. This corresponds to a fuzzy partition of the running window into sub-regions, such that each data-point l has a membership gₖ(l) in region k, and the sum of memberships of each point is 1.

In addition the effective number of data-points (the sum of memberships) in each of the regions k, is equal, which can be expressed as Σₗgₖ(l)=L/K, and thus can be weighted equally. The hypothesis testing component 118 further identifies one of the profiles as corresponding to the “region of interest”, and designates it as the “reference profile” in order to further examine collective properties or feature characteristics of a region for detecting coherent changes (changes localized in time and space). For notational convenience the reference profile will have index k=1. In addition for notational convenience, the normalized location within the window is x(l)=(2l−L+1)/2L, such that −0.5<x(l)<0.5, and the middle of the window, corresponding to l=(L−1)/2, is at x(l)=0.

The profile combination component 120 is configured to receive the results of the hypothesis testing as expressed in a similarity likelihood parameter related to the likelihood that data samples on the right-half (e.g., profile 208) of the window and left-half (e.g., profile 204) come from the same distribution, which is further detailed below. Based on the results of the hypothesis test from the hypothesis testing component 118, the profile combination component 120 combines the weight-profiles according to similarity into a final combined weight profile g_{L}, (which can operate as a rank-based change-adaptive weighting metric/function) which is received by the weight profile computation component 124. The resulting adaptive weighting g_{L} can maintain, for example, the normalization to L/K.

The weight profile computation component 124 is configured to generate a final adaptive weight profile with the adaptive weight profile g_{L} and the non-adaptive weight profile W_{L} as defined above from the fixed sample weighting component 104. For example, the weight profile computation component 124 can multiply the adaptive weighting g_{L} with the non-adaptive weight profile Ink to generate a final adaptive weight profile W_{L}=g_{L}·w_{L} (which can further operate as a rank-based change-adaptive weighting metric/function). Given the final adaptive weight profile W_{L}, together with the corresponding sample data values y_{L} and their corresponding normalized ranks r_{L} (together denoted as Y[r_{L}])_{,} a number of techniques can produce a meaningful filtered value representing a neighborhood around a data-point of interest while accounting for statistic changes, such as according to a weighted mean or some other robust statistical descriptor or characteristic from the adaptively weighted samples and ranks.

After attributing weights to the window data, whether adaptively or not, a set of ranked samples y_{L}=y(l) with normalized ranks r=r(l) and weights W_{L}=W(l) is provided to an Empirical Cumulative Distribution Function (ECDF) component 126 that is configured to construct an estimator of the distribution from which the sample was drawn F(x), also known as the empirical-CDF or ECDF. The ECDF value for each x is the estimated probability for a random value X drawn from the underlying distribution to be smaller than x given the empirical weighted data:

F^{e}(x|y_{L},r_{L},W_{L})=P(X<x|y_{L},r_{L},W_{L}); Eqn. 2

There are various algorithms and approximation methods to compute the ECDF given y_{L}, r_{L}, and W_{L}. The standard piecewise constant approximation is given by the cumulative mass (sum of weights) for all data samples smaller than x. The sums involved are conveniently expresses via the sample ranks r:

$${F}^{e} ( x \vert {y}_{L} , {r}_{L} , {W}_{L} ) = \frac{{\sum }_{( r : y [ r ] < x )} {W}_{[ r ]}}{{\sum }_{r} {w}_{[ r ]}} ; . \qquad Eqn . 3$$

In another example, a smoother form of piecewise-linear approximation can also be used here.

A basic characteristic component 128 can extract from the ECDF, several key distribution characteristics that can be used as key performance indicators (PKIs), such as a characteristic central value 130 (mean/median etc.), and variability scale 132 (standard deviation—STD/inter-quartile range IQR etc.). The reliability of decision and alerts based on each of these statistical estimators, depends on how robust is the estimator against a variety of conditions. In particular we need to be robust for the case of long tailed distributions. The mean, and its corresponding variability indicator—STD are known not to be robust to neither, since even a small portion of very large and/or very small samples can shift the estimator considerably from the true mean or STD of the underlying distribution. A well-known and more robust alternative to the mean is the median, which is the 50% percentile of the distribution. A corresponding variability indicator is the inter-quartile range IQR, which is the difference between the first and third quartiles (25% and 75% percentiles respectively).

Referring to FIG. 2, illustrated is one example of an adaptive weighting scheme 200 in accordance with various aspects of embodiments disclosed. A change-adaptive sample-weight profile, for example, can take a characteristic value of the window-center as reference and weigh neighboring samples by their similarity to that central characteristic. Normalized ranks 202 of each sample relative to other samples in the window are computed. A difference in rank-means, for example, is computed in the different window regions, which is different from computing the difference between mean-values in different window regions. Rather than comparing the difference value to an arbitrary threshold, the probability is estimated for the null hypothesis that the local means of ranks do not depend on the position within the window.

In one embodiment, three position dependent weight-profiles 204, 206 and 208 are defined (e.g., via the rank profile component 116) that are positioned in the left/center/right third of the window, and can employ a modified Wilcoxon rank-sum non-parametric test to obtain p-values for the null-hypothesis of position-independence. Determining the null-hypothesis distribution is done for any given window size such as by a simulation (e.g., a Monte-Carlo simulation). The adaptive weight profile 200 is computed as a weighted combination of the three weight-profiles 204, 206, 208 where the weights correspond to the p-values. This way, the adaptive weight profile suppresses the weights of certain parts of the local window only if they their distribution is different from the reference central part with sufficient statistical significance. This is achieved in a soft-decision manner independently of imposing any thresholds and without assuming particular parametric models of local statistics. In general, a number of weight-profile alternatives other than three may be used, as detailed in the examples sections below.

FIG. 3 illustrates an example of an empirical cumulative distribution function (ECDF) profile in accordance with various aspects of embodiments disclosed. After computing sample weights in a window block and sample ranks are computed, an ECDF 300 is generated. For example, a weighted-empirical cumulative distribution function (W-ECDF) is graphed with the horizontal axis as the sample values and the vertical axis as the cumulative property of the samples. The X value demonstrates the weighted mean of the distribution 300, an O represents the weighted median, and the plus (+) value represents a weighted mode, where delta F represents the range of the weighted mode as concentrated in the vertical axis of cumulative probability, and the delta y the range of sample y values along the horizontal axis. A main mode location and spread can be found by e.g. the “shortest half” method which finds the probability range (delta F) containing 50% of the probability mass, which spans the shortest range (shortest corresponding delta y). The ends of the delta-y range correspond to the main mode spread while the mode location can be estimated as the value y corresponding to the middle of the range delta-F or as the weighted mean of values within the range delta-F. There are a variety of other methods to estimate the location and spread main mode of an ECDF.

From the ECDF of FIG. 3, various empirical distribution characteristics can serve as key performance indicators (KPIs). For example, the mean, median, main-mode and/or like statistical characteristics, as well as statistical characteristic variability indicators (e.g., standard deviation STD, inter-quartile range, mode-spread, etc.), and distribution asymmetry indication can be computed as a KPI.

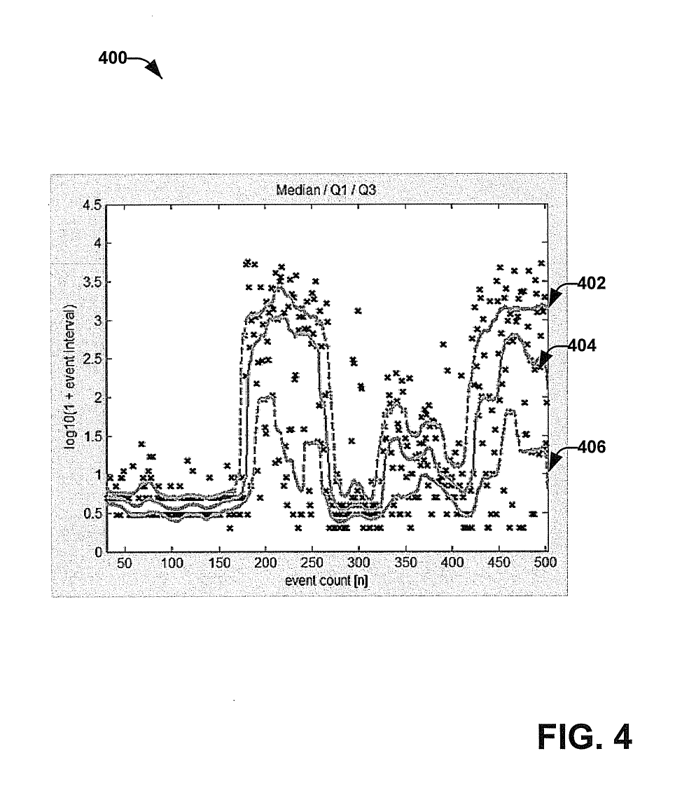

FIG. 4 illustrates the application of the analysis suit to a data stream originating from an event log of a printer, where the raw data (the x marks), corresponds to a series of intervals between successive printer-error events (in terms of number of printed pages). The horizontal axis corresponds to event-interval counts (rather than actual time). The vertical axis corresponds to event-intervals, where a logarithmic scale is used due to their wide range of magnitudes (characteristic of long tailed distributions). The central, middle curve 404 corresponds to the running “characteristic” value of event-interval—corresponding in fact to the running adaptive weighted median, while the lower and upper curves 406 and 402 correspond to the running adaptive quartiles (Q1 & Q3 respectively). The local statistical spread corresponds to the inter-quartile range Q3-Q1 which is the difference between the upper and lower curves 402, 406. It is possible to appreciate the adaptivity of the estimated curves by observing that in regions where the raw data seems to have one main mode they stay close and jump together at points of significant change of distributions, while at regions where there are two distinct modes (a concentration of high value point, and a separate concentration of low value points), one of the quartile curves is much more separated from the median than the other curve—indicating strong asymmetry of the distribution at those points. This asymmetry can be quantified in a normalized manner by the parameter S=(Q1+Q3−2*Med)/(Q3−Q1).

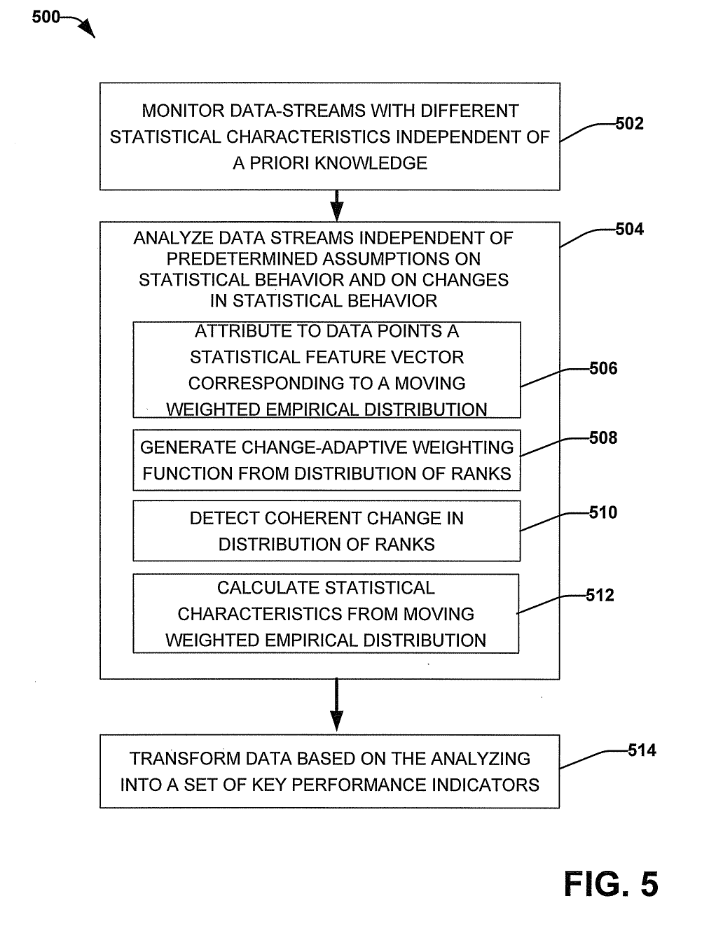

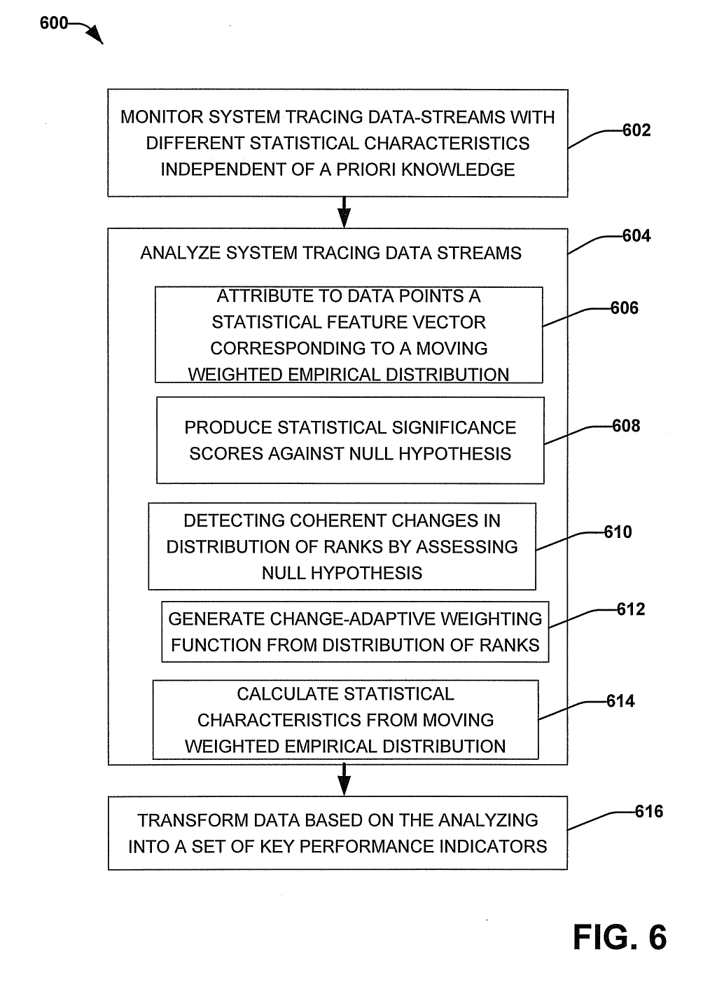

FIGS. 5 and 6 illustrate various methodologies in accordance with certain embodiments of this disclosure. While, for purposes of simplicity of explanation, the methodologies are shown and described as a series of acts within the context of various flowcharts, it is to be understood and appreciated that embodiments of the disclosure are not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be further appreciated that the methodologies disclosed hereinafter and throughout this disclosure are capable of being stored on an article of manufacture to facilitate transporting and transferring such methodologies to computers. The term article of manufacture, as used herein, is intended to encompass a computer program accessible from any computer-readable device or storage media.

Referring now to FIG. 5, illustrated is a methodology 500 for adaptive sample weighting, as discussed above. At 502, a computing device comprising a processor that processes data-streams related to operation tracing and performance indication. The data-streams (e.g., component signal footprints sensed over time or other received data-streams) can have different dynamic statistical characteristics that include a mixture of distributions with respect to time, such as a static and non-static signal distributions that do not fit into any one model distribution and can overlap multiple distribution models, for example. The data-streams have different dynamic statistical characteristics that are independent of a priori knowledge and do not have any modeled assumptions since the statistical characteristics of the data-streams are dynamic and unpredictable, such as with long/heavy tailed, frequently changing, etc., for example.

At 504, the data-streams are analyzed independently of predetermined assumptions on statistical behavior and/or on changes in the statistical behavior. For example, the analysis can comprise a block-wise analysis on running (overlapping) blocks of predetermined length L, such as windows of intervals of event occurrence data monitored. In one embodiment the system tracing data-streams are analyzed independent from assumptions on any predetermined data distribution shapes, scale, and threshold due to the dynamic nature of the analysis.

In another embodiment, at 506, a set of data-points is attributed a statistical feature vector corresponding to a moving weighted empirical distribution of data values in a temporal neighborhood (sample window). The relative weight for each data sample in the temporal neighborhood is determined according to a set of data adaptive processes.

At 508, a change-adaptive weighting function is generated from a distribution of ranks. For example, the change-adaptive weighting function is generated by analyzing a distribution of ranks of a first set of data samples that are relative to a second set of data samples within an event point neighborhood. At 510, the method 500 includes detecting a set of coherent changes in the distribution of ranks across the temporal neighborhood. A sample weight profile of the distribution of ranks can then be weighed according to the set of coherent changes detected to generate an adaptive weighting profile. At 512, statistical characteristics can be calculated from the moving weighted empirical distribution, in which the statistical characteristics included the set of key performance indicators corresponding, but not limited, to a variability indicator, upper/lower variability indicators and/or a distribution asymmetry indicator.

At 514, for the data-points several statistical characteristics from a computed statistic feature vector (e.g., the ECDF) are calculated, which can include, as stated above, a central-tendency indicator, upper/lower variability indicators and/or a distribution asymmetry indicator. Key performance indicators (KPIs) can thus be extracted from the analysis. The KPIs can be related to the local signal level, and/or the local signal spread (variability, volatility, etc.). In one embodiment, a straight forward option that is both robust and fast to compute is to utilize the median of the local empirical distribution (50% quantiles) and the difference between third and first quartile (75% to 25% quantiles). Yet, a more sophisticated and robust estimator of signal level and spread can be computed based on the local empirical information, such as main-mode location and spread.

Referring to FIG. 6 illustrates one example of a method 600 in accordance with various embodiments described in this disclosure. The method 600 initiates at 602 by monitoring system tracing data-streams related to operation tracing and performance indication. The system tracing data-streams have different dynamic statistical characteristics that are independent of a priori knowledge. In other words, the system tracing data-streams do not have any modeled assumptions since the statistical characteristics of the data-streams are dynamic and unpredictable. Wild signals (e.g., long/heavy tailed, frequently changing, etc.) can be embodied by the system's dynamic tracing data-streams. Therefore, previous knowledge (a priori) of the statistical characteristics or nature of the data stream is unknown, and monitoring of the data streams is performed without knowledge or modeling of the statistical behavior beforehand.

At 604, the system analyzes system tracing data-streams independent of predetermined assumptions on statistical behavior for the system tracing data-streams and on changes in the statistical behavior. Thus, because no predictable knowledge is accurate for complex systems having multiple statistical distributions throughout the operational tracing and performance indication, analysis of the statistical characteristics of the tracing data-streams is independent of any assumptions or modeled behavior of the statistical characteristics.

At 606, a set of data-points is attributed a statistical feature vector corresponding to a moving weighted empirical distribution of data values in a temporal neighborhood. A relative weight for each data sample in the temporal neighborhood is determined according to a set of data adaptive processes. At 608, statistical significance scores are produced for a plurality of hypothesis against a null hypothesis relative to a temporal neighborhood of a data-point. In one embodiment, the plurality of hypothesis comprises a first hypothesis that is tested based on a local trend with a test statistic being a fitted line slope of data sample ranks versus a position of the data sample ranks relative to a first region (e.g., center region) of the temporal neighborhood, and a second hypothesis that is tested based on a mean rank of data samples in a second region (e.g., a central third) of the temporal neighborhood being similar to a third region (e.g., left-third) mean rank of the temporal neighborhood, or to a right-third mean rank of the temporal neighborhood to generate a change adaptive sample weight profile. Although, the example above provides for testing in three different regions of a distribution of ranks for a distribution of data samples, any number of regions or weight profiles corresponding to a region can be tested.

At 610, Coherent changes are detected in a distribution of ranks by assessing a randomness of ranks that includes assessing a null hypotheses that data samples come from a same distribution by producing the statistical significance scores against the null hypothesis relative to the temporal neighborhood of the data-point by comparing between profile-mean ranks of weight profiles corresponding to different regions of the temporal neighborhood. Thus, a data value is given a statistical feature vector corresponding to a moving weighted empirical distribution of the data values in the temporal neighborhood of the data-point. A relative weight for each data sample in the temporal neighborhood is determined according to data adaptive processes, as discussed herein that estimates a probability of the null hypothesis. At 612, the method further comprises generating a rank-based change-adaptive weighting function by analyzing a distribution of ranks of the first set of data samples that are relative to a second set of data samples within an event point neighborhood. At 614, the method further comprises calculating for each point several statistical characteristics from the computed statistical feature vector (the ECDF). The computed statistical characteristics include, but are not limited to a central-tendency indicator, upper/lower variability indicators and/or a distribution asymmetry indicator.

At 616, the statistical indicators computed from the statistical feature vector, and from the change-detection process are transformed as discussed above, into a set of meaningful KPIs according to the meaning of the data and the type of decision support that is needed. For example, when analyzing event-occurrence data as in the example given above, the KPIs may include (but are not limited to), the central tendency indicator (instantaneous event-rate), variability indicator (instantaneous event-rate stability), distribution asymmetry or “mixed-mode” indicator (fluctuation between event-rate modes), and signed-change indicator (significant event-rate increase/decrease), and more.

Advantages of the methods disclosed herein related to the generality and independence of signal-model assumptions. Some of the advantages that the methods embody are as follows: 1. The data can have a large variety of distribution models because the methods are purely model-free, (e.g., non-parametric); 2. The distributions can have all varieties of tail behavior (e.g., short/regular/long/heavy-tailed distributions)—the methods herein are statistically very robust and work consistently for all types of distributions within a system; 3. The distributions change frequently both abruptly and gradually, in which the methods handle well both abrupt and gradual distribution changes even when in proximity, and provides robust and credible change indication from relative small data-windows (e.g., temporally coherent trends and changes are credibly detectable within ˜15 data samples) with correspondingly short detection delay.

An additional advantage is that the sensitivity of the alarms derived from the change/trend indicator is easier to tune for particular applications, since the indicators have a clear meaning of change/trend likelihood and lay the range of 0-1. Hence, alarm thresholds have clear probabilistic meaning and no prior knowledge on the signal statistics is needed to set alarm threshold, so as to avoid excessive false alarms. This also facilitates the generalization of the analysis to handle multiple related signals that may have completely different ranges and belong to different statistical distribution types. The change/trend indicators for different signals can be compared and correlated, since they were brought to a common range with similar probabilistic meaning.

### Examples of Rank-Based Change-Adaptive Weighting

One example of a rank-based change adaptive weighting (e.g., via the adaptive weighting component 114) can be found in a causal-filtering scenario using two box-shaped profiles as follows:

g₁(x)={0(−0.5<x<0);0.5(x=0);1(0<x<0.5)},(right-half of the window);

g₂(x)={1(−0.5<x<0);0.5(x=0);0(0<x<0.5)},(left-half of the window).

The right-half profile g₁(x) is selected as the reference-profile. The adaptive weighting component 114 operates to assess if earlier available samples (left half) come from a same distribution as the more recent data samples (right half) of a window. If data samples are estimated to come from the same distribution, the adaptive weighting component 114 provides both sides of the window equal weights to gain more statistics (noise suppression). However, if the data samples are estimated to come from different distributions, only the more recent data samples are focused on (e.g., the right-half samples) and the less recent left-half data samples that are statistically different (change resilience) are weighed down.

The adaptive weighting component 114 is operable to implement adaptive trade-off between noise-suppression and change preservation to provide running-window change indicators via the change estimation component 122. For example, following adaptive weight-profile combination formula can be implemented by the adaptive weighting component 114 to implement the adaptive trade-off between noise-suppression and change preservation: g(x)=[g₁(x)+p₁₂ g₂(x)]/[1+p₁₂], where p₁₂ is a similarity-likelihood parameter that indicates a likelihood that the hypothesis tested by the hypothesis testing component 118 is true or not.

For example, the similarity-likelihood parameter p₁₂ is related to the likelihood that the samples on the right-half g₁(x) and left-half g₂(x) come from the same distribution, which is described in greater detail infra. In the case p₁₂→0 (left-half is highly unlikely to come from the same distribution as right-half), the resulting adaptive weight profile is designated the reference profile g(x)→g₁(x). In the other extreme case p₁₂→1 (left-half is highly likely to come from the same distribution as right half), the resulting adaptive weight profile is a flat profile across the window g(x)→[g₁(x)+g₂(x)]/2=0.5 (for all x), i.e. all window samples get the same weight. Note that the resulting weight profile maintains the normalization to UK. The weight profile computation component 124 receives the resulting adaptive weighting g(l) and multiplies it with a non-adaptive weight profile, as described above, to provide the final adaptive weight profile Wₗ=W(l)=g(l)·w(l). As stated discussed above, the weight profile W(l), together with the corresponding samples y(l) and their normalized ranks r(l), can be received by the ECDF estimation component 126 to produce a meaningful filtered value representing the neighborhood around the point of interest while accounting for statistical changes.

The hypothesis testing component 118 determines an estimate of the similarity-likelihood parameter p₁₂ by considering a test statistic z₁₂ that corresponds to the difference between the profile-mean ranks of g₁(x) and g₂(x), and is defined as follows:

$${z}_{12} = \frac{{\sum }_{l} {g}_{1} ( l ) \cdot r ( l )}{{\sum }_{l} {g}_{1} ( l )} - \frac{{\sum }_{l} {g}_{2} ( l ) \cdot r ( l )}{{\sum }_{l} {g}_{2} ( l )} = \frac{K}{L} {\sum }_{l} [ {g}_{1} ( l ) - {g}_{2} ( l ) ] \cdot r ( l )$$

The hypothesis testing component 118 is configured to assess the probability that the resulting value of z₁₂ (or larger absolute values) could have been obtained by pure chance under the “null”-hypothesis that the samples in region 1 are drawn from the same distribution as the samples in region 2 of the window of the profile-distribution of ranks (e.g., the profile-mean ranks of g₁(x) and g₂(x),). For this, the distribution of the test-statistic z₁₂ under the null-hypothesis, F₀(z₁₂) is determined. For the particular case of two box-profiles and with L even, the test statistic z₁₂ is linearly related to the rank-sum statistic used in the classical Wilcoxon rank-sum test, for which the null-distribution is known by tables for small values of L and by a normal approximation for larger values of L. For more general profiles of g₁(x), g₂(x) that are not flat (i.e. different samples may have different weights), there are no tables or closed-form approximation formulas. In order not to be limited to flat weight profiles, to the adaptive weighting component 114 approximates the desired null distribution F₀(z₁₂) by a simulation procedure that is performed in advance once for each pre-determined window size L, and profile-set gₖ(x). A statistical property of sample ranks is utilized that provides that the ranks of a sample of size L drawn from any continuous distribution have the same distribution. In particular, L-tuples are drawn from a uniform distribution using a standard random number generator, and for each tuple the ranks and subsequently the test-statistic are computed. The distribution of test values z₁₂ is thus obtained. The adaptive weighing component 114 operates to estimate the distribution of z₁₂ under the null hypothesis, for example, by a Monte-Carlo simulation drawing a sufficiently large number of L-tuples (e.g., N˜10000), and then the “empirical cumulative distribution function” (ECDF) of the N values of the test statistic, F₀^{{N}}(z₁₂) is determined, in which the larger N, the more accurate the estimation.

Because the theoretical null-distribution is symmetrical about z₁₂=0, with F₀(0)=0.5, the similarity-likelihood parameter is determined as a ratio of the probability that the test-value would be further apart from 0 than z₁₂ (larger than or smaller than z₁₂ according to its sign), to the complementary probability: p₁₂=min[F₀(z₁₂), 1−F₀(z₁₂)]/max[F₀(z₁₂), 1−F₀(z₁₂)]; p₁₂→0 for F₀(z₁₂)→0 or F₀(z₁₂)→1 (i.e. the ranks in region 1 are consistently-larger or consistently-smaller than ranks in region 2—meaning the samples in the two regions are unlikely to be drawn from the same distribution), where F₀(z₁₂)] is the estimation of the null hypothesis distribution. On the other hand, p₁₂→1 for F₀(z₁₂)→0.5 (i.e. each rank of a sample in region 1 is equally likely to be larger or smaller than the rank of any sample in region 2).

Consequently, the probability-ratio parameter p₁₂ obtained with these techniques has the desired properties for the weight-profile combination formula described above. For example, p₁₂ is in fact a statistical “non-change” indicator that complies with the desired objectives of the system 100—independence of assumptions on distribution shape, scale and location. The similarity-likelihood parameter p₁₂ value has clear statistical interpretation and direct correspondence with the statistical significance of the evidence supporting the no-change assumption. In addition, the similarity-likelihood parameter p₁₂ can be converted (e.g., via the change estimation component 122) to a change-indicator via −log₂(p₁₂) which gives 0 for p₁₂→1, and increases indefinitely as p₁₂→0. Further, a signed change indicator can be determined, which in the case of change indicates if the values and ranks tend to be higher in region 1 or region 2. This is done by incorporating the sign of F₀(z₁₂)−0.5. The formula for the signed change indicator is thus: C₁₂=−log₂(p₁₂)·sgn[F₀(z₁₂)−0.5].

The adaptive-weighting procedure that is described above is not limited to the box-profile pair that appeared in the example. For example, gradual profile pairs can also be processed rather than only the box-profile pair. Gradual profile pairs, for example, can be clipped linear profiles parameterized by an abruptness-scale parameter s (0<s≦1). Example profiles are as follows:

g₁{s}(x)=0.5+max[−0.5,min(0.5,x/s)](right-weights higher than left);

g₂{s}(x)=0.5−max[−0.5,min(0.5,x/s)](right-weights higher than right)

where s=1 corresponds to linear profiles g_{1,2}(x)=0.5±x, and s→0 corresponds to the abrupt box-profiles like in the detailed example above.

The signed change indicator corresponding to this profile set (C₁₂ in the formula above), is a statistical significance measure for a consistent tendency of value increase or decrease from one end of the window to the other. The abruptness parameter, s can be tuned to be more sensitive to gradual changes, abrupt changes, or some trade-off between the two. In any case, the adaptive-weight determination and change-indication are independent of the contrast of the change, the shape of the distributions involved, and they are only weakly dependent on the change abruptness. In other words, the processes described are applicable to a large variety of signal-change cases with almost no prior model assumptions other than the window-size L.

The “rank-based change-adaptive weighting” described so far is not limited to use with only two profiles, and can be implemented with any number of weight-profiles (rank weight profiles).

For any set of K weight profiles (each corresponding to a region in the window), that adhere to the conditions prescribed above (Σₗgₖ(l)=L/K; Σₖgₖ(l)=1), the adaptive-weight profile is computed by

g(x)=[g₁(x)+Σ_{k>1}p₁ₖgₖ(x)]/[1+Σ_{k>1}p₁ₖ],

where the similarity likelihood parameters p₁ₖ correspond to the likelihood that the samples in region k are taken from the same distribution as the samples in region 1 (the region of interest). Each of the similarity likelihood parameters p₁ₖ is estimated by applying the hypothesis testing procedure described above to the test statistic z₁ₖ=K/L·Σₗ[g₁(l)−gₖ(l)]·(l). The null distribution of all z₁ₖ is estimated, for example, by a Monte-Carlo simulation on ranks of L-tuples drawn from a uniform distribution as described above. The simulation needs to be performed only once for each L.

For example, an adaptive weighting scheme using K=3 weight profiles corresponding to left/middle/right parts of the window can be implemented. This scheme accounts for more complex information on the change structure across the window, than the previously described scheme with K=2 profiles at additional computational cost. In particular the operation of the adaptive weighting component 114 adapts to both monotonic shaped changes (steps/slopes), and peak/dip shaped changes, in which formulas for such a profile set can be parameterized by abruptness-scale parameter s in the range (0<s≦⅔). Example profiles are as follows:

g_{left}(x)=0.5−max[−0.5,min(0.5,(x+⅙)/s)];

g_{right}(x)=0.5+max[−0.5,min(0.5,(x−⅙)/s)];

g_{mid}(x)=1−g_{left}(x)−g_{right}(x)=max[−0.5,min(0.5,(x+⅙)/s)]−max[−0.5,min(0.5,(x−⅙)/s)].

For s→0, three non-overlapping box-profiles are obtained that each cover one third of the data sample window. For s=⅔, the left profile is linearly decreasing across the left two thirds of the window from x=−½ to ⅙, the mirror right profile is linearly increasing across the right two thirds of the window from x=−⅙ to ½, while the middle profile has a flat maximum of value 0.5 at the center third of the window (|x|≦⅙), and decreases linearly towards a value of 0 at the window ends (x=±½). One selected setting is the intermediate value s=⅓ where the left and right profiles have clipped linear shapes that drop to 0 at x=0 so they do not have any overlap, while the mid profile has a symmetric triangular shape dropping from 1 in the middle (x=0) to 0 at x=±⅓. This setting corresponds to the intuitive notion of fuzzy partition of the window into left/mid/right, such that the left-most sixth is purely “left”, the next third is a gradual transition from pure “left” to pure “middle”, the next third is a gradual transition from pure “middle” to pure “right”, and the right-most sixth corresponds to pure “right”.

The above tri-profile set can be used either in a causal filtering mode (with g_{right} as the reference profile), anti-causal mode (g_{left} as reference), or symmetric non-causal mode (g_{mid} as reference), which is illustrated in the weighting scheme 200 as graphed in FIG. 2 discussed above.

### Example Component Architecture

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated herein.

With reference to FIG. 7, a suitable environment 700 for implementing various aspects of the claimed subject matter includes a computer 702. The computer 702 includes a processing unit 704, a system memory 706, a codec 735, and a system bus 708. The system bus 708 couples system components including, but not limited to, the system memory 706 to the processing unit 704. The processing unit 704 can be any of various available processors. Dual microprocessors and other multiprocessor architectures also can be employed as the processing unit 704.

The system bus 708 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 706 includes volatile memory 710 and non-volatile memory 712. The basic input/output system (BIOS), containing the basic routines to transfer information between elements within the computer 702, such as during start-up, is stored in non-volatile memory 712. In addition, according to present innovations, codec 735 may include at least one of an encoder or decoder, wherein the at least one of an encoder or decoder may consist of hardware, software, or a combination of hardware and software. Although, codec 735 is depicted as a separate component, codec 735 may be contained within non-volatile memory 712. By way of illustration, and not limitation, non-volatile memory 712 can include read only memory (ROM), programmable ROM (PROM), electrically programmable ROM (EPROM), electrically erasable programmable ROM (EEPROM), or flash memory. Volatile memory 710 includes random access memory (RAM), which acts as external cache memory. According to present aspects, the volatile memory may store the write operation retry logic (not shown in FIG. 7) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 702 may also include removable/non-removable, volatile/non-volatile computer storage medium. FIG. 7 illustrates, for example, disk storage 714. Disk storage 714 includes, but is not limited to, devices like a magnetic disk drive, solid state disk (SSD) floppy disk drive, tape drive, Jaz drive, Zip drive, LS-100 drive, flash memory card, or memory stick. In addition, disk storage 714 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 714 to the system bus 708, a removable or non-removable interface is typically used, such as interface 716. It is appreciated that storage devices 714 can store information related to a user. Such information might be stored at or provided to a server or to an application running on a user device. In one embodiment, the user can be notified (e.g., by way of output device(s) 736) of the types of information that are stored to disk storage 714 and/or transmitted to the server or application. The user can be provided the opportunity to opt-in or opt-out of having such information collected and/or shared with the server or application (e.g., by way of input from input device(s) 728).

It is to be appreciated that FIG. 7 describes software that acts as an intermediary between users and the basic computer resources described in the suitable operating environment 700. Such software includes an operating system 718. Operating system 718, which can be stored on disk storage 714, acts to control and allocate resources of the computer system 702. Applications 720 take advantage of the management of resources by operating system 718 through program modules 724, and program data 726, such as the boot/shutdown transaction table and the like, stored either in system memory 706 or on disk storage 714. It is to be appreciated that the claimed subject matter can be implemented with various operating systems or combinations of operating systems.

A user enters commands or information into the computer 702 through input device(s) 728. Input devices 728 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 704 through the system bus 708 via interface port(s) 730. Interface port(s) 730 include, for example, a serial port, a parallel port, a game port, and a universal serial bus (USB). Output device(s) 736 use some of the same type of ports as input device(s) 728. Thus, for example, a USB port may be used to provide input to computer 702 and to output information from computer 702 to an output device 736. Output adapter 734 is provided to illustrate that there are some output devices 736 like monitors, speakers, and printers, among other output devices 736, which require special adapters. The output adapters 734 include, by way of illustration and not limitation, video and sound cards that provide a means of connection between the output device 736 and the system bus 708. It should be noted that other devices and/or systems of devices provide both input and output capabilities such as remote computer(s) 738.

Computer 702 can operate in a networked environment using logical connections to one or more remote computers, such as remote computer(s) 738. The remote computer(s) 738 can be a personal computer, a server, a router, a network PC, a workstation, a microprocessor based appliance, a peer device, a smart phone, a tablet, or other network node, and typically includes many of the elements described relative to computer 702. For purposes of brevity, only a memory storage device 740 is illustrated with remote computer(s) 738. Remote computer(s) 738 is logically connected to computer 702 through a network interface 742 and then connected via communication connection(s) 744. Network interface 742 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 744 refers to the hardware/software employed to connect the network interface 742 to the bus 708. While communication connection 744 is shown for illustrative clarity inside computer 702, it can also be external to computer 702. The hardware/software necessary for connection to the network interface 742 includes, for example purposes only, internal and external technologies such as, modems including regular telephone grade modems, cable modems and DSL modems, ISDN adapters, and wired and wireless Ethernet cards, hubs, and routers.

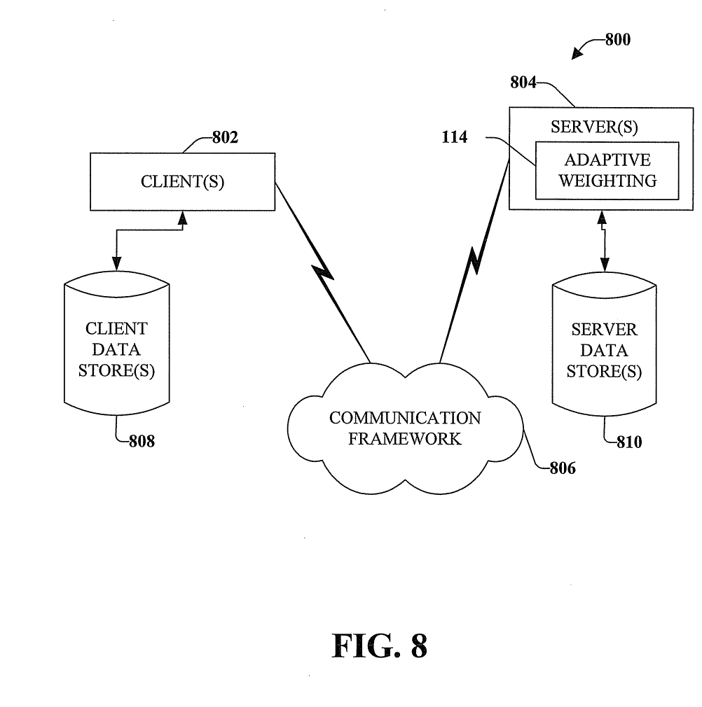

Referring now to FIG. 8, there is illustrated a schematic block diagram of a computing environment 800 in accordance with this specification. The system 800 includes one or more client(s) 802 (e.g., laptops, smart phones, PDAs, media players, computers, portable electronic devices, tablets, and the like). The client(s) 802 can be hardware and/or software (e.g., threads, processes, computing devices). The system 800 also includes one or more server(s) 804. The server(s) 804 can also be hardware or hardware in combination with software (e.g., threads, processes, computing devices). The servers 804 can house threads to perform transformations by employing aspects of this disclosure. For example, the server(s) 804 can include the system 100 illustrated in the FIG. 1 and/or components of the system such as the adaptive weighting component 114, in which the server(s) 804 can operate to manage and communicate the components of the system 100 as resources to the client(s) 802 and/or another server. One possible communication between a client 802 and a server 804 can be in the form of a data packet transmitted between two or more computer processes wherein the data packet may include video data. The data packet can include a cookie and/or associated contextual information, for example. The system 800 includes a communication framework 806 (e.g., a global communication network such as the Internet, or mobile network(s)) that can be employed to facilitate communications between the client(s) 802 and the server(s) 804.

Communications can be facilitated via a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804.

In one embodiment, a client 802 can transfer an encoded file, in accordance with the disclosed subject matter, to server 804. Server 804 can store the file, decode the file, or transmit the file to another client 802. It is to be appreciated, that a client 802 can also transfer uncompressed file to a server 804 and server 804 can compress the file in accordance with the disclosed subject matter. Likewise, server 804 can encode video information and transmit the information via communication framework 806 to one or more clients 802.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. Moreover, use of the term “an embodiment” or “one embodiment” throughout is not intended to mean the same embodiment unless specifically described as such.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated example aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both tangible, volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

What is claimed is:

1. A method comprising:
analyzing, with a computing device comprising a processor, data-streams independent of predetermined assumptions on statistical behavior and on changes in the statistical behavior, wherein the data streams comprise different dynamic statistical characteristics including static signal distributions and non-static signal distributions with respect to time; and
transforming data based on the analyzing into a set of key performance indicators and performance-change indicators that are adaptive to instantaneous statistical changes.

2. The method of claim 1, further comprising:
attributing to a set of data-points a statistical feature vector corresponding to a moving weighted empirical distribution of data values in a data-point neighborhood, wherein a relative weight for each data sample in the data-point neighborhood is determined according to a set of data adaptive processes; and
calculating statistical characteristics from the moving weighted empirical distribution, the statistical characteristics including the set of key performance indicators corresponding to an instantaneous central-tendency indicator, an instantaneous variability indicator or an instantaneous distribution asymmetry indicator.

3. The method of claim 2, wherein the data adaptive processes include determining a probability of a null hypothesis that a data-point and a neighboring data sample are taken from a same statistical distribution.

4. The method of claim 2, wherein the attributing and the analyzing is performed independent from assumptions on any predetermined data distribution shape, scale and location parameters.

5. The method of claim 2, wherein the attributing further comprises:
factoring temporal changes in a local distribution of local statistical characteristics of a first set of data samples; and
computing data sample ranks relative to other data samples of different intervals to obtain an empirical cumulative distribution function of the data samples that is adapted to local changes based on a rank-based change adaptive weighting metric.

6. The method of claim 4, further comprising:
generating a rank-based change-adaptive weighting function by analyzing a distribution of ranks of the first set of data samples that are relative to a second set of data samples within the data-point neighborhood.

7. The method of claim 6, further comprising:
detecting a set of coherent changes in the distribution of ranks across the data-point neighborhood; and
weighing a sample weight profile of the distribution of ranks according to the set of coherent changes detected to generate an adaptive weighting profile.

8. The method of claim 7, wherein the weighing of the sample weight profile includes determining a probability of a null hypothesis that a data-point and a neighboring data sample are taken from a same statistical distribution by determining the probability that the distribution of ranks is random and that the sample weight profile includes a temporal structure.

9. The method of claim 2, further comprising:
detecting coherent changes in a distribution of ranks by assessing a randomness of ranks that includes assessing a null hypotheses that data samples come from a same distribution by producing statistical significance scores against the null hypothesis relative to the data-point neighborhood of the set of data-points by comparing between profile-mean ranks of weight profiles corresponding to different regions of the data-point neighborhood.

10. The method of claim 1, further comprising:
approximating a null distribution by performing a simulation in advance for each pre-determined window size and a set of weight profiles, by determining a set of L tuples N times, wherein L and N is an integer greater than one, and computing ranks for each tuple and a test statistic.

11. The method of claim 10, further comprising:
determining an empirical cumulative distribution function of test values of the test statistic;

12. A computer readable storage medium comprising computer executable instructions that, in response to execution, cause a computing system comprising at least one processor to perform operations, comprising:
determining a rank-based change adaptive weighting metric to detect coherent changes in a data sample distribution across a window;
assessing a randomness of ranks in a distribution of ranks across the window, independently of a-priori knowledge of a data sample distribution shape, scale and location parameters; and
calculating statistical characteristics from an empirical cumulative distribution function based on the rank-based change adaptive weighting metric.

13. A system that translates system tracing data-streams comprising different dynamic statistical characteristics to performance indicators, comprising:
a memory that stores computer executable components; and
a processor that executes the following computer executable components stored in the memory:
an adaptive weighting component to determine a rank-based change adaptive weighting metric that detects coherent changes in a data sample distribution across a window and assess a randomness of ranks in a distribution of ranks across the window, independently of a-priori knowledge of a data sample distribution shape, scale and location parameters; and
a basic characteristic component to calculate statistical characteristics from an empirical cumulative distribution function based on the rank-based change adaptive weighting metric, the statistical characteristics including the performance indicators corresponding to an instantaneous central-tendency indicator, an instantaneous variability indicator or an instantaneous distribution asymmetry indicator.

14. The system of claim 13, further comprising:
a rank profile component to compute a localized set of weight profiles based on ranks;
a hypothesis testing component to assess a null hypothesis that data samples in the window come from a same distribution, without any assumptions on a data sample distribution shape and scale, by producing statistical test for statistical significance scores against the null hypothesis and comparing between profile-mean ranks of the set of weight profiles corresponding to different regions of the window; and
an profile combination component to (1) receive hypothesis testing results in a similarity likelihood parameter that indicates a likelihood that the data samples of a first region of the window and from a second region left-half come from the same distribution and (2) combine weight profiles of the set of profiles of the first region and the second region according to a similarity into a final combined weight profile.

15. The system of claim 13, further comprising:
a running window component to perform a block-wise analysis on running blocks of data of predetermined length L, in which a neighborhood of values is sampled as the window;
a ranking of samples component to compute data sample ranks in the distribution of ranks; and
an empirical cumulative distribution function component to determine the empirical cumulative distribution function based on the rank-based change adaptive weighting metric.
